(19) United States
(12) Patent Application Publication
(10) Pub. No.: US 2013/0074291 A1
(43) Pub. Date: Mar. 28, 2013

(54) ORNAMENTAL PIN FASTENER FOR GARMENTS

(71) Applicant: Leilani Ozzard, Agassiz (CA)

(72) Inventor: Leilani Ozzard, Agassiz (CA)

(21) Appl. No.: 13/277,128

(22) Filed: Oct. 19, 2011

Related U.S. Application Data
(60) Provisional application No. 61/538,722, filed on Sep. 23, 2011.

(51) Int. Cl. A44B 17/00; F16B 47/00

(52) U.S. Cl. 24/304; 24/595.1

(57) ABSTRACT

A garment fastener is provided. The fastener has a body with a catch provided thereon, and a pin having a free end that is selectively latchable with the catch. At least a portion of the pin is spaced apart from the body. An elastically compressible is between the body and the portion of the pin spaced apart from the body. The elastically compressible member may be configured to space the body apart from a garment penetrated by the pin, and may be configured to support the body in generally parallel relation to a garment where the garment is penetrated by the pin.

### CROSS-REFERENCE TO RELATED APPLICATION

This application claims the benefits, under 35 U.S.C.§119(e), of U.S. Provisional Patent Application Ser. No. 61/538,722 filed Sep. 23, 2011 which is pending and incorporated herein by this reference.

### TECHNICAL FIELD

The invention relates to fasteners for garments. Particular embodiments of the invention provide fasteners for securing undergarment straps to outer-garments.

### BACKGROUND

Some undergarments, such as brassieres, camisoles and the like, include over-shoulder straps for holding the undergarments against the body and/or anchoring the undergarments against the weight of parts of the body (e.g. breasts). These straps may be susceptible to sliding outwardly along the natural curve of a wearer's shoulder. A strap which has slid outwardly along its wearer's shoulder may be uncomfortable and/or unsightly, particularly if the undergarment is worn beneath a sleeveless garment.

Outward sliding of an over-shoulder strap may be prevented by fastening the strap to a garment worn over the strap using a pin fastener. However, pin fasteners may be unsightly (e.g., having an undesirably utilitarian appearance).

Patent literature describing technology in the general field of this invention includes:
U.S. Pat. No. 776,279, Watkins—“Pin catch”;
U.S. Pat. No. 1,645,649, King—“Pin”;
U.S. Pat. No. 1,489,267, Mendel—“Fastening for brooches and like articles”;
U.S. Pat. No. 1,731,163, Gedney—“Collar pin”;
U.S. Pat. No. 2,006,923, Jones—“Safety pin and spring therefore”;
U.S. Pat. No. 3,590,830, Hannum—“Barrette”;
U.S. Pat. No. 3,605,438, Chalson—“Bar pin with changeable non-rotatably secured ornament and intermediate member”;
U.S. Pat. No. 5,441,188, Rosenstein—“Shoulder strap and jewelry retainer”;
U.S. Pat. No. 5,771,545, Ellenberger—“Garment strap retainer”;
U.S. Pat. No. 5,996,593, Horman—“Hair clip”;
U.S. Pat. No. 6,257,251, Burleson et al.—“Cushion coated hair clip having low-friction surfaces”;
U.S. Pat. No. 6,324,734, Joseph—“Safety pin attachment”;
U.S. Pat. No. 7,461,661, Chudzik et al.—“Hair clip with friction member”;
U.S. Pat. No. 7,766,020, Chinnis et al.—“Hair retaining clip with resilient gripping member”;
US 2004/0182412, Vogel—“Hair clip”; and
Great Britain patent no. 161262, Conroy—“Improvements in slides or brooches for the hair”.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

An aspect of the invention provides a garment fastener having a body, a catch provided on the body, and a pin having a free end selectively latchable with the catch. At least a portion of the pin is spaced apart from the body. The garment fastener includes an elastically compressible member between the body and the portion of the pin spaced apart from the body. The elastically compressible member may be configured to space the body apart from a garment penetrated by the pin. In some embodiments, the elastically compressible member is configured to support the body in generally parallel relation to a garment where the garment is penetrated by the pin. The elastically compressible member may be shaped so that when a garment is captured between the pin and the body, the elastically compressible member contacts the garment to inhibit rotation of the body about the pin. In some embodiments, a face of the elastically compressible member spaced apart from the body is intersected by a tangent between the pin and an edge of the body.

Another aspect of the invention provides a kit for enhancing performance of a garment fastener comprising a body, a catch provided on the body and a pin having a free end selectively latchable with the catch, at least a portion of the pin spaced apart from the body, the kit including an elastically compressible member and adhesive. In some embodiments, the adhesive is pre-applied to the elastically compressible member.

A further aspect of the invention provides a method for enhancing the performance of a garment fastener comprising a body, a catch provided on the body and a pin having a free end selectively latchable with the catch, at least a portion of the pin spaced apart from the body, the method including coupling an elastically deformable member to the body at a location between the body and the pin. In some embodiments, the method comprises compressing the elastically deformable member between the body and a garment penetrated by the pin.

In addition to the exemplary aspects and embodiments described above, further aspects and embodiments will become apparent by reference to the drawings and by study of the following detailed descriptions.

### BRIEF DESCRIPTION OF DRAWINGS

In drawings that show non-limiting example embodiments:

FIG. 1 is a schematic cross-sectional side elevation view of an ornamental pin fastener.

FIG. 2 is a schematic front elevation view of the pin fastener shown in FIG. 1.

FIG. 3 is a schematic side elevation view of a pin fastener according to an example embodiment.

FIG. 4 is a schematic bottom plan view of the pin fastener shown in FIG. 3.

FIG. 5 is a schematic end elevation view of the pin fastener shown in FIG. 3.

FIG. 6 is a schematic side elevation view of an example use of the pin fastener shown in FIG. 3.

FIG. 7 is a schematic side elevation view of another example use of the pin fastener shown in FIG. 3.

### DESCRIPTION

Throughout the following description specific details of non-limiting example embodiments are set forth in order to provide a more thorough understanding to persons skilled in the art. Well known elements may not have been shown or described in detail to avoid unnecessarily obscuring the disclosure. Accordingly, the description and drawings are to be regarded in an illustrative, rather than a restrictive, sense.

The appearance of a pin fastener used to secure an undergarment strap against outward sliding along the shoulder may be improved by the addition of ornamentation. In some embodiments, pin fasteners comprise ornamentation (e.g., ornamental designs applied to the pin fastener, ornamental members coupled to the pin fasteners, etc.) that faces away from the elements fastened by the fastener.

Where a pin fastener comprises a pin that is generally smooth bodied and round in cross-section, or when the pin passes through a hole in the garment that is larger than the cross-section of the pin, it may occur that the pin fastener rotates about the axis of its pin (e.g, under force of gravity). Where this occurs to a pin fastener comprising ornamentation, the pin fastener may be rotated to a position in which the ornamentation faces at least partially downwardly.

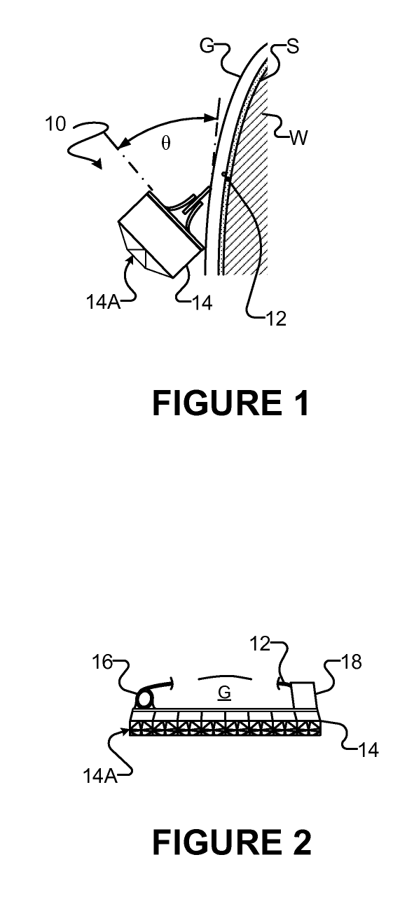

FIG. 1 shows a cross-sectional side elevation view of an ornamental pin fastener 10 according to an example embodiment. FIG. 2 shows a front elevation view of pin fastener 10. Fastener 10 comprises a pin 12, which penetrates a strap S and a garment G. Strap S conforms generally to the body of its wearer W. Because pin 12 is generally smooth and round in cross-section (or because the holes in strap S and/or garment G through which pin 12 passes are larger than the cross-section of pin 12) fastener 10 is rotatable about the axis of pin 12. Since pin 12 is spaced apart from the body 14 of fastener 10, gravity acting on body 14 results in a torque generally oriented about the axis of pin 12. As shown in FIG. 1, this torque may cause fastener 10 to rotate about the axis of pin 12 until further rotation is inhibited by contact between body 14 and garment G.

Rotation of fastener 10 is inhibited at an orientation in which an ornamental face 12A of body 12 faces downwardly away from wearer W. As shown in FIG. 1, in this orientation, the plane of ornamental member 14A lies at an angle θ to the plane tangent to garment G where it is penetrated by pin 12. FIG. 2 is a schematic front elevation view of the FIG. 1 pin fastener 10, which shows that when fastener 10 has pivoted to the orientation shown in FIG. 1, pin 12, hinge 16 and catch 18 are visible from the front, and the face 14A of ornamental member 14 is only partially visible from the front.

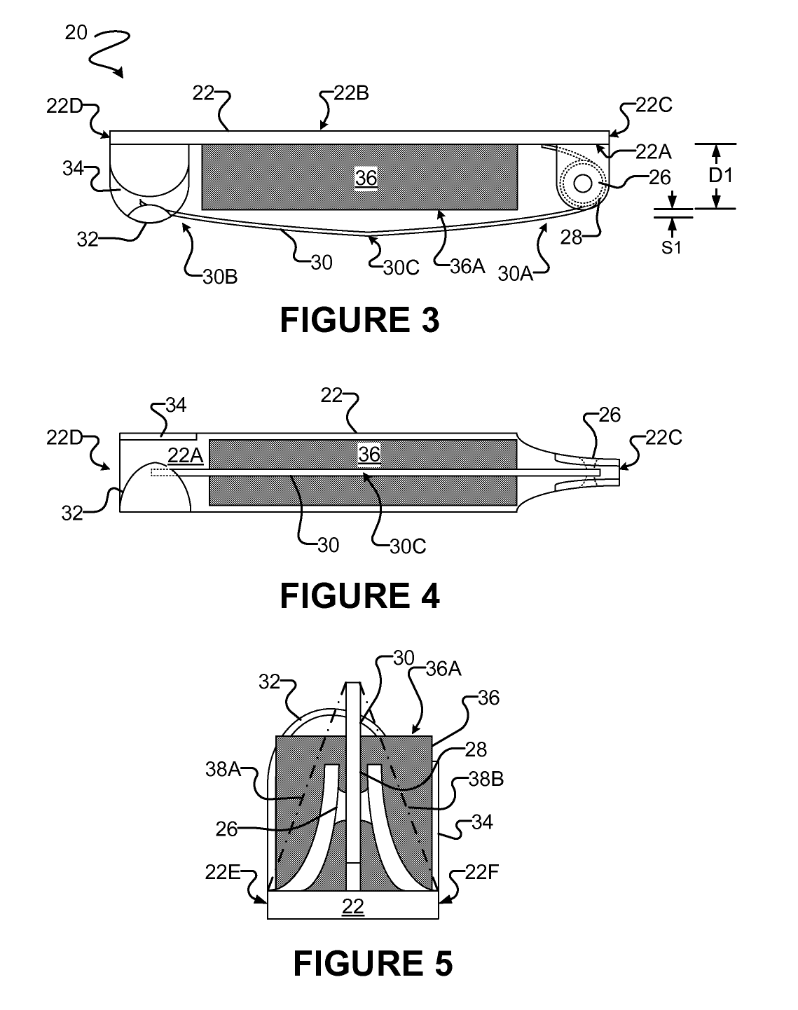

FIGS. 3, 4 and 5 are schematic side elevation, bottom plan and end elevation views of a pin fastener 20 according to an example embodiment. Fastener 20 comprises a generally flat body 22 having a first face 22A. Body 22 also has a second face 22B, which is generally opposite first face 22A. Second face 22B may comprise ornamentation (e.g., an ornamental design, an ornamental member mounted thereon, or the like).

A pin 30 is coupled at its first end 30A to first face 22A at a first end 22C thereof. More particularly, in the illustrated embodiment, a coil 28 formed at first end 30A of pin 30 is mounted on a hub 26 coupled to body 22 adjacent first face 22A and at the first end 22C thereof. First end 30A of pin 30 proximate coil 28 abuts first face 22A of body 22, inhibiting rotation of coil 28 about hub 26.

A second, free end 30B of pin 30 is selectively latchable with a catch 32. Catch 32 is coupled to body 22 adjacent first face 22A and at the second end 22D thereof. When second end 30B of pin 30 is held by catch 32 a central portion 30C of pin 30 is spaced apart from first face 22A of body 22. Second end 30B of pin 30 may be unlatched from catch 32 by displacing second end 30B toward body 22 against the restorative force of coil 28, and moving it laterally out of catch 32. An optional guard 34 opposite catch 32 reduces the likelihood of second end 30B being inadvertently removed from catch 32.

It will be appreciated that the coupling of pin 30 to body 22 and the latching of pin 30 with catch 32 are conventional features of pin fasteners. In general, pin fasteners according to embodiments may comprise any suitable form of coupling of pin 30 to body 22 and any suitable mechanism for latching pin 30 with catch 32.

Fastener 20 comprises an elastically compressible member 36 between body 22 and central portion 30A of pin 30, which is spaced apart from body 22. In the illustrated embodiment, member 36 is coupled to first face 22A of body 22. FIGS. 3, 4 and 5 show member 36 in its uncompressed condition. When member 36 is in its uncompressed condition, its face 36A is spaced apart from first face 22A of body. In its uncompressed condition, member 36 has depth D1 along the direction normal to face 22A of body 22—see FIG. 3. In some embodiments, D1 is greater than 0.125 inches. In some embodiments, D1 is less than 0.375 inches. In some embodiments, D1 is in the range of 0.2 inches to 0.3 inches.

In the embodiment shown in FIGS. 3, 4, and 5, face 36A of member 36 is spaced apart from pin 30 when member 36 is in its uncompressed condition. In some embodiments, face 36A of member 36 is separated from pin 30 by a space S1 when member 36 is in its uncompressed condition—see FIG. 3. In some embodiments, S1 is less than 0.125 inches. In some embodiments, S1 is in the range of 0 inches to 0.2 inches. In some embodiments, face 36A abuts at least part of pin 30 when member 36 is in its uncompressed condition. In some embodiments, member 36 is compressed by at least part of pin 30 when second end 30B of pin 30 is latched with catch 32.

As shown in FIG. 5, tangent 38A, which extends between longitudinal edge 22E and pin 30, and tangent 38B, which extends between longitudinal edge 22F and pin 30, each intersect member 36 (more particularly face 36A) when member 36 is in its uncompressed condition. That is, when member 36 of the illustrated embodiment is in its uncompressed condition, at least part of member 36 extends past tangents 38A and 38. While in the illustrated embodiment member 36 spans the width of body 22 and transversely overlaps pin 30, this is not necessary. In some embodiments, member 36 is transversely spaced apart from pin 30. For example, member 36 may have the form of a strip that is adjacent edge 22E and transversely spaced apart from pin 30; it will be appreciated that member 36 according to this example is intersected by tangent 38A.

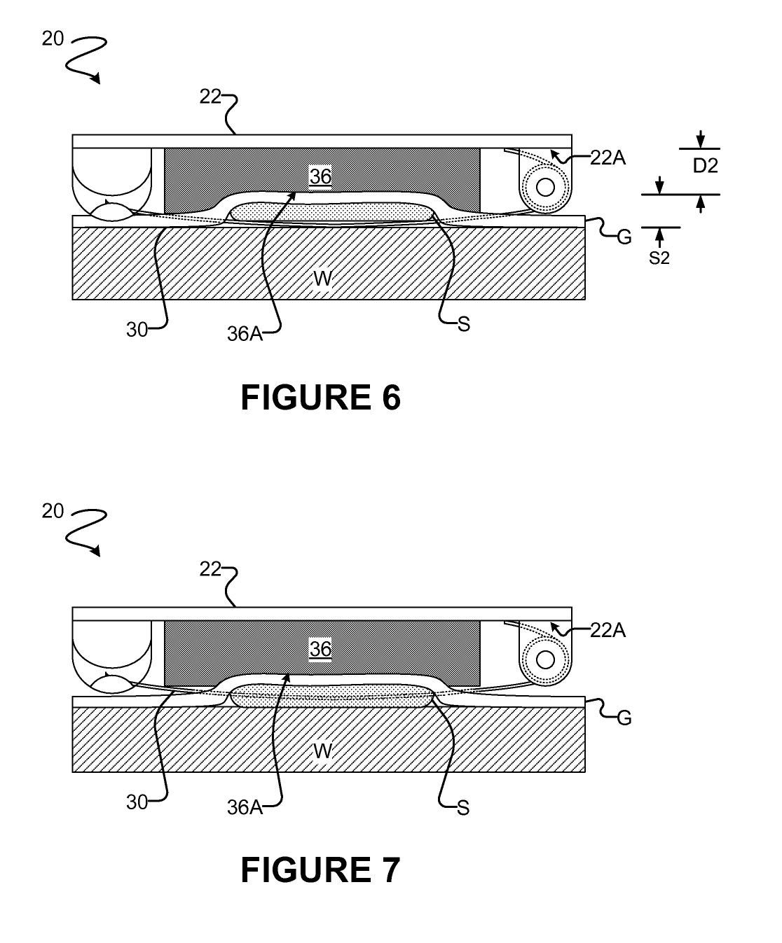

FIG. 6 is a schematic side elevation view of fastener 20 in an example use. In the example use shown in FIG. 6, pin 30 penetrates a garment G and passes between the body of wearer W and a strap S. Garment G and strap S occupy at least part of the space between pin 30 and body 22. At least a central portion of compressible member 36 is compressed between body 22 and garment G. In this compressed condition, member 36 occupies less of the space between pin 30 and body 22 than it does in its uncompressed condition (i.e., because garment G and strap S occupy a part of the space that was occupied by member 36 when member 36 was in its uncompressed condition).

As shown in FIG. 6, when member 36 is compressed between body 22 and garment G, the central portion of face 36A of member 36 is separated from pin 30 by a space S2, which is greater than space S1. As can also be see in FIG. 6, when member 36 is compressed between body 22 and garment G, the central portion of member 36 has depth D2, which is less than depth D1.

FIG. 7 is a schematic side elevation view of fastener 20 in another example use. The example use shown in FIG. 7 is similar to that shown in FIG. 6, but differs in that pin 30 penetrates both garment G and strap S.

When pin fastener 20 is used as shown in FIGS. 6 and 7, the restorative deformation forces that tend to cause of member 36 to return to its uncompressed condition also cause member 36 to apply forces against the body of wearer W (through garment G and strap S) and against body 22. The force member 36 exerts on body 22 of fastener 20 inhibits downward rotation of fastener 20 about pin 30 under gravity, and spaces body 22 apart from garment G. In some embodiments, member 36 is configured such that the force it applies against body 22 supports body 22 in generally parallel relation to the body of wearer W against the force of gravity.

Because member 36 is compressible, a range of depths of garments and straps may be accommodated between face 36A and pin 30. Advantageously, this may permit fastener 20 to be used with a variety of different garments (e.g., t-shirts, blouses, finely-knit sweaters, chunky-knit sweaters, jackets, coats, etc.) and straps (e.g., plain, lace, ruffled, etc.). In some embodiments, member 36 is configured to be compressible to a depth of less than 75% of its uncompressed depth D1 under pressure of 5 pounds per-square inch (PSI) (which may be representative of moderate finger pressure). In some embodiments, member 36 is configured to be compressible to a depth of less than 50% of its uncompressed depth D1 under pressure of 5 PSI. In some embodiments, member 36 is configured to be compressible to a depth of less than 25% of its uncompressed depth D1 under pressure of 5 PSI.

In some embodiments, member 36 is configured so that a pressure of less than 5 PSI applied to face 36A compresses member 36 such that face 36A is spaced apart from pin 30 by a space S2 of at least 0.125 inches. In some embodiments, member 36 is configured so that a pressure of less than 5 PSI applied to face 36A compresses member 36 such that face 36A is spaced apart from pin 30 by a space S2 of at least 0.2 inches.

It will be understood that as used herein with respect to an elastically compressible member (such as member 36, for example), the term “uncompressed condition” may include a condition in which the member is compressed by a pin of an associated fastener (such as pin 30, for example) or a portion thereof. Accordingly, the term “uncompressed condition” should be understood as meaning relatively uncompressed when compared to the compressed condition. That is to say, a member in its uncompressed condition, whether or not the member is compressed, is more closely spaced to an associated pin than the member is in its compressed condition.

In some embodiments, member 36 is configured to conform to the surface of garment G captured between pin 30 and body 22 (i.e., member 36 may be elastically conformable). For example, member 36 may conform to the surface of garment G by deforming longitudinally (e.g., member 36 may be elastically conformable along its length) and/or tranversely (member 36 may be elastically conformable across its width). Advantageously, where member 36 is configured to conform to the surface of garment G, body 22 may be oriented more nearly parallel to the body of wearer W.

In the illustrated embodiment, member 36 comprises a solid slab. More particularly, member 36 comprises a solid rectangular slab which extends transversely across substantially the entire width of face 22A of body 22 (i.e., between opposite longitudinal edges 22E and 22F of body 22) and longitudinally along face 22A of body 22 between hub 26 and catch 32. In some embodiments, member 36 is not solid. For example, member 36 may have a tubular configuration (e.g., with axis transverse to the length of body 22, parallel to the length of body 22, etc.). In some embodiments, member 36 comprises one or more apertures (e.g., member 35 may comprise a honeycomb configuration of apertures) and/or one or more hollows (e.g., member 35 may comprise an inflated, elastically compressible envelope).

Member 36 may comprise any suitably elastic material. In some embodiments, member 36 comprises a material which as a solid slab is sufficiently compressible to perform as described herein. Foam is but one non-limiting example of such a material. Non-limiting examples of types of foam that member 36 may comprise include polyurethane foam, synthetic rubber foam, rubber latex foam, or the like. For example, in some embodiments, member 36 comprises a solid slab of foamed neoprene rubber. In some embodiments, member 36 comprises a solid slab of material having a Shore 00 hardness in the range of 10-25. In some embodiments, member 36 comprises a plurality of different materials (e.g., member 36 may comprises a slab formed of a plurality of layers of different materials).

In some embodiments, member 36 comprises elastic material, which as a solid slab is not sufficiently compressible to perform as described herein, but which when formed in an appropriate shape configuration (e.g., tubular, honeycomb, inflated envelope, etc.) is sufficiently compressible to perform as described herein. For example member 36 may comprise rubber, cork, leather, and/or other elastic material formed in a resiliently compressible shape configuration.

Member 36 may be coupled to face 22A of body 22 using any suitable coupling. In some embodiments, member 36 is adhesively coupled to face 22A of body 22. In some embodiments, member 36 is mechanically coupled to face 22A of body 22 (such as, for example, by interlocking or snap fit engagement of corresponding coupling members formed or otherwise provided on face 22A and member 36).

An elastically compressible member (such as member 36, for example) and adhesive may be provided as a kit for enhancing a pin fastener to provide an enhanced pin fastener (such as fastener 20, for example). In some embodiments, the adhesive is pre-applied to the member, such as in the manner of an adhesive layer covered by a removable cover. In some embodiments, the adhesive is provided as a separate component (e.g., a tube of adhesive, a double sided adhesive tab, etc.).

The performance of garment fasteners may be enhanced by method embodiments. For example, the performance of a garment fastener comprising a body, a catch provided on the body and a pin having a free end selectively latchable with the catch, at least a portion of the pin spaced apart from the body may be enhanced by coupling an elastically deformable member to the body at a location between the body and the pin. In example methods for enhancing garment fastener performance include compressing the elastically deformable member between the body and a garment penetrated by the pin.

Where a component (e.g. a body, catch, pin, elastically compressible member, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Those skilled in the art will appreciate that certain features of embodiments described herein may be used in combination with features of other embodiments described herein, and that embodiments described herein may be practised or implemented without all of the features ascribed to them herein. Such variations on described embodiments that would be apparent to the skilled addressee, including variations comprising mixing and matching of features from different embodiments, are within the scope of this invention.

As will be apparent to those skilled in the art in the light of the foregoing disclosure, many alterations and modifications are possible in the practice of this invention without departing from the spirit or scope thereof. For example:
fasteners according to some embodiments may comprise a plurality of elastically compressible members;
elastically compressible members need not span the width of the fastener face to which they are coupled;
elastically compressible members need not be adjacent both longitudinal edges, or either longitudinal edge, of the fastener face to which they are coupled;
elastically compressible members may have slab configurations other than rectangular, such as cylindrical (e.g., extruded circle or ellipse), extruded obround, spherical segment, ellipsoid segment, cylindrical segment, trapezoidal, prism, and the like, for example;
bodies of pin fasteners need not be elongate (e.g., they may be circular, square, etc.);
bodies of pin fasteners need not be flat (e.g., they and/or their faces may be curved, undulating, etc.);
faces of elastically compressible members proximate to bodies of pin fasteners need not be flat (e.g., they may be shaped to conform to the face of which they are proximate in their uncompressed condition);
faces of elastically compressible members proximate pins need not be flat (e.g., they may be undulating, curved, etc.);
faces of elastically compressible members proximate pins need not be parallel to the associated body (e.g., they may be transversely slanted to achieve a particular orientation of the body with respect to the garment where the garment is penetrated by the pin, etc.)
pins need not be generally aligned with the longitudinal dimension of the bodies to which they are coupled (e.g., they may be transverse to the longitudinal dimension of the bodies to which they are coupled);

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A garment fastener comprising:
a body;
a catch provided on the body;
a pin having a free end selectively latchable with the catch, at least a portion of the pin spaced apart from the body; and
an elastically compressible member between the body and the portion of the pin spaced apart from the body.

2. A garment fastener according to claim 1 wherein the elastically compressible member is coupled to the body.

3. A garment fastener according to claim 1 wherein the elastically compressible member is shaped to space at least a portion of the body apart from a garment penetrated by the pin.

4. A garment fastener according to claim 3 wherein the elastically compressible member is shaped to support the body in generally parallel relation to the garment where the garment is penetrated by the pin.

5. A garment fastener according to claim 1 wherein the elastically compressible member is shaped so that when a garment is captured between the pin and the body, the elastically compressible member contacts the garment to inhibit rotation of the body about the pin.

6. A garment fastener according to claim 1 wherein the elastically compressible member is intersected by a tangent between the pin and an edge of the body.

7. A garment fastener according to claim 6 wherein the body is elongate, wherein the edge comprises a longitudinal edge of the body, and the elastically compressible member is intersected by a plane tangent to the pin and the edge.

8. A garment fastener according to claim 1 wherein the elastically compressible member transversely overlaps the pin.

9. A garment fastener according to claim 8 wherein the elastically compressible member extends substantially across the dimension of the body transverse to the pin.

10. A garment fastener according to claim 1 wherein the elastically compressible member is transversely spaced apart from the pin.

11. A garment fastener according to claim 1 wherein the elastically compressible member is elastically conformable.

12. A garment fastener according to claim 1 wherein the elastically compressible member has substantially uniform thickness along its length in its uncompressed condition.

13. A garment fastener according to claim 9 wherein the elastically compressible member comprises a slab configuration.

14. A garment fastener according to claim 1 wherein the elastically compressible member is configured to be compressible to a depth of less than 75% of its uncompressed depth under pressure of 5 PSI.

15. A garment fastener according to claim 1 wherein the elastically compressible member is configured to be compressible to a depth of less than 50% of its uncompressed depth under pressure of 5 PSI.

16. A garment fastener according to claim 1 wherein the face of the elastically compressible member abuts the pin when the elastically compressible member is in an uncompressed condition.

17. A kit for enhancing performance of a garment fastener comprising a body, a catch provided on the body and a pin having a free end selectively latchable with the catch, at least a portion of the pin spaced apart from the body, the kit comprising:
an elastically compressible member; and
adhesive.

18. A kit according to claim 18 wherein the adhesive is pre-applied to the elastically compressible member.

19. A method for enhancing the performance of a garment fastener comprising a body, a catch provided on the body and a pin having a free end selectively latchable with the catch, at least a portion of the pin spaced apart from the body, the method comprising:
coupling an elastically deformable member to the body at a location between the body and the pin.

20. A method according to claim 19 comprising:
compressing the elastically deformable member between the body and a garment penetrated by the pin.
